(19) United States
(12) Patent Application Publication
(10) Pub. No.: US 2002/0110505 A1
(43) Pub. Date: Aug. 15, 2002

(54) Reformer process with variable heat flux side-fired burner system

(76) Inventors: Shoou-I Wang, Allentown, PA (US); David Hon Sing Ying, Allentown, PA (US); Hoanh Nang Pham, Allentown, PA (US); Blaine Edward Herb, Fogelsville, PA (US); Xianming Li, Orefield, PA (US)

Correspondence Address: AIR PRODUCTS AND CHEMICALS, INC., PATENT DEPARTMENT, 7201 HAMILTON BOULEVARD, ALLENTOWN, PA, 181951501

(21) Appl. No.: 09/741,284

(22) Filed: Dec. 20, 2000

(51) Int. Cl. F28D 21/00; B01J 10/00

(52) U.S. Cl. 422/198; 422/187; 422/236

(57) ABSTRACT

An apparatus for heating a fluid in a process having a process heat requirement includes a shell, at least one tube having a design temperature inside the shell, a plurality of burners adjacent the inner wall of the shell, and transfer means whereby flue gas flows from a first interior region to a second interior region of the shell. A first portion of the tube is in the first interior region and a second portion of the tube is in the second interior region. The first and second portions of the tube are adapted to contain a flow of the fluid. The burners produce the flue gas in the first interior region and a variable heat flux approximating the process heat requirement and simultaneously maximizing the heat flux to the first portion of the tube while maintaining substantially all of the first portion of the tube at the design temperature.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates to processes involving the heating of fluids, such as processes for the production of a gas containing hydrogen and carbon oxides by steam reforming a hydrocarbon feedstock, and in particular to an apparatus and method for hydrocarbon reforming processes, hydrocarbon cracking processes, and heating of fluids.

Although the invention is discussed within the context of steam reforming of hydrocarbons, the invention is not limited to use with such processes. The steam reforming process is a well known chemical process for hydrocarbon reforming. A hydrocarbon and steam mixture (a mixed-feed) reacts in the presence of a catalyst to form hydrogen, carbon monoxide and carbon dioxide. Since the reforming reaction is strongly endothermic, heat must be supplied to the reactant mixture, such as by heating the tubes in a furnace or reformer. The amount of reforming achieved depends on the temperature of the gas leaving the catalyst; exit temperatures in the range of 700°-900° C. are typical for conventional hydrocarbon reforming.

Conventional catalyst steam reformer processes combust fuel to provide the energy required for the reforming reaction. In a reformer of such a conventional process, fuel typically is fired co-current to incoming cold feed gas to achieve a high average heat flux through the tube wall(s) by radiant heat transfer directly from the flame. Downstream from the burner end, both the product gas and the flue gas exit at relatively high temperatures.

FIG. 1 illustrates a conventional upflow, up-fired cylindrical reformer 10 (or furnace) having three burners 12 located therein. Tubes 14 are filled with catalyst and run the height of the reformer 10. A process fluid mixture enters through the inlet headers 18 and is injected into the tubes 14. The fluid mixture travels through the catalyst-filled tubes and exits to the outlet headers 16. The fluid mixture within the tubes is heated almost completely by radiant heat transfer from the burners 12 within the reformer. Only one side of the tube sees direct radiation from the flame, which results in non-uniform heating around the tube circumference. The flue gas exiting through the stack 15 is at a very high temperature.

To recover the sensible heat from the product syngas, prior art hydrocarbon reforming processes use a tube within a tube (tube-in-tube) arrangement with catalyst in the annuli. The feed absorbs heat from the combustion side of the furnace through the outside tube wall. The reformed gas flow is reversed at the end of the catalyst bed and enters the inner-most passage of the tube. The reformed gas then gives up heat to the counter-current flow of the incoming cold feed.

When the catalyst is fresh, a large fraction of the heat that is transferred through the tube is absorbed by the endothermic reactions that take place at high rates. When the catalyst in this region is deactivated (poisoned), the endothermic reactions occur at a slower rate and absorb a smaller fraction of the heat. As a result, the temperature of the process gas in this region is elevated and the tendency for coking/overheating the tube greatly increases.

U.S. Pat. No. 3,230,052 (Lee, et al.) discloses a terraced heater containing two rows of vertical catalyst-filled tubes (in a staggered arrangement). Each longitudinal wall of the furnace is made up of a series of planar surfaces that form a series of steps. The base of each step incorporates a series of troughs that run along the length of the furnace and incorporate (linear) burners. The burners inject flames into each trough to substantially fill each trough. The combustion is completed within the trough. The hot flue gases sweep over the inclined planar walls above each trough. The objective is to heat the inclined refractory wall to a (relatively) uniform temperature attempting to achieve a uniform heat intensity (heat flux) to the tubes in that section of the furnace. By altering the firing rate of any set of paired burners disposed at the same elevation, different zones of tubes can be subjected uniformly to heat intensities suitable for the reaction rate attainable therein. However, no information is provided on how the heat flux to each vertical section should differ and what determines the amount of fuel to be fired within each elevation. The fuel is burned and releases its heat of combustion at three discrete elevations in the furnace and the inclined vertical refractory walls are used in an attempt to evenly heat the tubes.

U.S. Pat. No. 3,182,638 (Lee, et al.) discloses a fired heater design that utilizes the same type of burners as disclosed in U.S. Pat. No. 3,230,052. Burners are located only on the floor. The furnace is divided into multiple cells using additional refractory faced walls. The object is to achieve a uniform heat flux to the serpentine tubes in each zone. The magnitude of heat transferred in each cell can be adjusted by controlling the fuel flow rate to each cell via trough burners firing along opposing walls.

U.S. Pat. No. 5,199,961 (Ohsaki, et al.) discloses an apparatus for catalytic reaction having a lower radiant heat transfer space and an upper space designed to enhance convective heat transfer to the vertical tubular reactor. In a similar manner as described in U.S. Pat. Nos. 3,182,638 and 3,230,052, burner assemblies (called linear burners) are located along the furnace floor between rows of tubes. These burners fire upward along the vertical refractory walls. The intent is to distribute the heat to the tubes more evenly along the height of the tube and to attempt to provide approximately equal heat flow to each tubular reactor. The fuel is burned and releases its heat of combustion at only one elevation in the furnace. This approach does not solve the problem of how to tailor the heat flux distribution along the height of the tubular reactor with the heat flux distribution required by the process (to achieve a uniform tube metal temperature over a substantial height of the reactor and to hold this temperature in close approach to the tube design limits). The approach described by this patent will tend to overheat the reactor tube wall in the vicinity of the burners.

U.S. Pat. No. 2,751,893 (Permann) discloses a radiant tubular heater and a method of heating. One object is to provide a method of achieving a uniform radiant heat flux around the circumference of the heater tube. To achieve this, Permann claims that the tube must be positioned in relation to a source of radiant heat in a manner to avoid direct impingement on the tube of the most intense part of the initial radiation and to distribute the radiant heat from the same source to opposite sides of the tubes by re-radiation from opposed radiating walls. This requires the tubes to be located between two refractory walls, with the burners located in the first. The tubes are not in the line-of-sight of the burners. A second object of the heater in U.S. Pat. No. 2,751,893 is similar to that of the terraced heater in U.S. Pat. No. 3,230,052 in that both attempt to achieve a distribution of radiant heat along the length of the tubes. Both arrangements require many individual burners at different elevations and positions (along the circumference or length and along the height of the furnace).

An article published in the Aug. 14, 1972 issue of The Oil and Gas Journal, titled A New Steam-Methane Reformer Gives High CO/H2 Ratio, provides information about a side-fired reformer designed by Selas Corporation of America. Many burners are located in multiple rows in both sidewalls of the furnace. The reformer tubes are placed in a single row. The actual operating practice of the plant applies the same firing rate to each burner and results in a more or less uniform heat flux along the height of the tube.

Another article published in the Feb. 1, 1971 issue of The Oil and Gas Journal, titled ASRT Heater—A Break from Tradition, provides information about the Short Residence Time (SRT) Heater Technology developed by Lummus Company. This heater contains a single row of tubes in a serpentine coil arrangement that is fired on both sides with many burners (process stream flows across furnace). The objective is to achieve a high heat flux to maximize capacity. Recognizing that tube operation is limited by maximum tube metal temperature, the goal is to achieve a tube temperature profile that is as uniform as possible along the entire tube height. The burners are manifolded to permit control of firing rate separately at the outlet and inlet ends of the coil. The article states that this approach does not reduce the flue gas temperature in the upper part of the furnace, because doing so normally would result in lower heat absorption in that area. Therefore, the furnace is fired throughout the height in an attempt to produce a uniform heat flux over an entire zone of the furnace and the flue gas exits at a relatively high temperature.

U.S. Pat. No. 4,959,079 (Grotz, et al.) discloses a furnace and process for reforming of hydrocarbons. The furnace consists of a radiant section and a convective section. The steam and hydrocarbon flow down through the catalyst-filled tube, first through the convective section and then through the radiant section. Fuel is fired in the radiant section and the combustion products flow counter-currently with the process gas in the convective section. To enhance the convective heat transfer in the convective section the width is reduced (resulting in higher flue gas velocities) and extended surfaces (fins) are added to the reformer tube.

U.S. Pat. No. 3,172,739 (Koniewiez) discloses an apparatus that comprises a natural-draft primary reforming furnace with an integral steam generator. The reforming furnace is cylindrical with reforming tubes arranged in a radial pattern inside an annulus. The central duct does not contain reformer tubes. A secondary burner fires into the central duct to provide for additional steam generation capability. Koniewiez does not discuss the problem of ensuring that (for each vertical slice of the furnace) each tube is heated uniformly around the circumference and that each tube segment receives the same amount of heat. Koniewiez also does not discuss the problem of ensuring that the amount of heat (heat flux) supplied to each segment of the tube does not cause the tube to overheat. No examples are given to illustrate that a practical design can be achieved with the primary floor-mounted burners. (The patent does state that additional burners may be positioned in the wall of the furnace and on the outer surface of the central duct.) There will be a very high tendency to locally overheat the bottom of the reformer tubes with floor-mounted burners. The outlet segment of the tube will run hot and will limit the firing rate and average heat flux (heating capacity). The remainder of the tube will be poorly utilized and will operate well below the design temperature. Floor mounted burners will restrict capacity, aggravate tube temperature, and increase tube wall thickness requirements.

U.S. Pat. No. 3,475,135 (Gargominy) discloses a reforming furnace design with a rectangular enclosure. Vertical reformer tubes are placed in a zigzag arrangement between the longitudinal walls of the enclosure. Two rows of burners are located on the longitudinal walls. Process flow is downward and the flue gas flow is also downward (co-current flow). This furnace also contains a lower section designed to enhance convective heat transfer. In the convective section, the tubes are enclosed in channels to increase the flue gas velocity and the channels are filled with refractory pellets. This design approach applies side-fired, down-flow reforming with co-current flow (process gas and flue gas exit at bottom of furnace). The modifications to increase the outside convective heat transfer coefficient are added to enhance the overall heat transfer at the outlet end of the tube. At this location, the temperature driving force (difference between the flue gas and outer tube skin temperature) is getting smaller. In contrast, when the flue gas exits counter to the incoming process gas, the heat transfer rate (primarily by radiation to inlet end of the bare tubes) is increased because of a larger temperature driving force.

U.S. Pat. No. 3,947,326 (Nakase, et al.) discloses a vertical tube type cracking furnace for ethylene and the like. Many burners are mounted along the side walls of the furnace to heat either one or two rows of vertical reaction tubes located between the sidewalls. The objective is to apply a uniform heat flux along the vertical tubes, which is not an optimal means to maximize thermal efficiency. (Optimizing thermal efficiency is not an objective of this patent, which teaches a method that actually results in a poor thermal efficiency.)

U.S. Pat. No. 5,993,193 (Loftus, et al.) discloses a Variable Heat Flux Low Emissions Burner, which is provided with a plurality of fuel gas inlets for enabling manipulation of the flame shape and combustion characteristics of the burner based upon variation in the distribution of fuel gas between the various fuel gas inlets. The purpose of this is to vary the pattern of heat flux being produced when the burner apparatus is in operation. However, this burner is a circular burner with intricate design, apparently aimed at achieving a great degree of premixing and reduced NOx emissions. More importantly, the heat flux pattern of this burner is a longitudinal heat flux distribution along the flame. This type of burner is not capable of tailoring the heat release profile to match the process requirements.

U.S. Pat. No. 5,295,820 (Bilcik, et al.) discloses a linear burner with a line of nozzles individually selected to operate by an electrically regulated distributor for the food industry. The intent is to have a burner with a wide range of heating power or turndown ratio.

It is desired to have an apparatus and a method for processes involving the heating of fluids (e.g., hydrocarbon reforming, cracking, and other processes) which overcome the difficulties, problems, limitations, disadvantages and deficiencies of the prior art to provide better and more advantageous results.

It is further desired to have a more efficient and economic process and apparatus for heating, reforming, or cracking hydrocarbon fluids or other fluids;

It is still further desired to have a reforming technology that will provide a higher thermal efficiency and production rate by overcoming the limitations inherent in the prior art.

It is still further desired to have a more efficient technology that also is applicable to other fired process heating applications, such as ethylene cracking furnaces.

It is still further desired to achieve a prescribed variable heat flux profile which matches the process heat requirement and maximizes the heat flux to the tubes in the lower (fired) region of a furnace.

It is still further desired to have an apparatus and a method for hydrocarbon reforming processes which has a simplified burner system located in one region (e.g.,the lower region) of the furnace that achieves a prescribed heat flux profile and makes maximum use of the tube(s) in the fired zone.

It also is desired to have an apparatus and method for hydrocarbon reforming processes which will:

transfer heat from the combustion space into the process at high rates (high average heat fluxes);

achieve high capacity in a compact furnace design with as few tubes as possible (maximum throughput per tube);

prevent the formation of hot spots on the tubes by achieving heat flux distributions, axial and circumferential, that supply the maximum amount of heat possible to a local section of the tube without causing it to overheat;

achieve the maximum possible radiant efficiency (minimum possible fuel consumption);

significantly reduce the potential for coking (hydrocarbon cracking, carbon formation, fouling, plugging) that commonly occurs near the process inlet end of the reformer tube;

avoid exceeding the tube design temperature limits (and avoid being constrained to operate with less efficient operating conditions, such as a high steam-to-carbon ratio and low process effluent temperature);

allow for operating flexibility to continue to achieve design production rates for an extended period of time;

reduce catalyst replacement cost by extending operating time for a charge of catalyst; and

simplify the burner system and associated piping, valves and controls to reduce capital and maintenance costs.

### BRIEF SUMMARY OF THE INVENTION

The invention is an apparatus and method for heating, reforming, or cracking hydrocarbon fluids or other fluids. The invention includes the use of a variable heat flux side-fired burner system for use in processes for heating, reforming, or cracking hydrocarbon fluids or other fluids.

A first embodiment of the apparatus includes: an elongated shell having an inner wall, a first end, and a second end opposite the first end; at least one elongated reaction chamber having a design temperature; a plurality of burners adjacent the inner wall; and transfer means adjacent the second end of the shell. The elongated shell has a first longitudinal axis, the shell being substantially symmetrical about the first longitudinal axis and enclosing a first interior region adjacent the first end and a second interior region adjacent the second end. Each of the first and second interior regions are substantially symmetrical about the first longitudinal axis. The at least one elongated reaction chamber has a second longitudinal axis substantially parallel to the first longitudinal axis. The reaction chamber is substantially symmetrical about the second longitudinal axis. A first portion of the reaction chamber is disposed in the first interior region of the shell, and a second portion of the reaction chamber is disposed in the second interior region of the shell. The first and second portions of the reaction chamber are adapted to contain a flow of the process fluid. Each of the burners is adapted to combust at least one fuel, thereby producing a flue gas in the first interior region of the shell and a variable heat flux. The variable heat flux substantially approximates the process heat requirement and simultaneously maximizes the heat flux to substantially all of the first portion of the reaction chamber while maintaining substantially all of the first portion substantially at the design temperature without substantially exceeding the design temperature. At least a portion of the flow of the flue gas flows from the first interior region of the shell to the second interior region of the shell via the transfer means.

In a preferred embodiment, the reaction chamber(s), which preferably is a tubular device, is a reformer tube. The tubular device may be a reformer radiant tube or a tube-in-tube device.

There are many variations of the first embodiment of the apparatus. In one variation, at least a portion of the process fluid flows through at least the first or second portion of the reaction chamber counter-currently with at least a portion of the flow of the flue gas. In another variation, a substantial portion of the reaction chamber is substantially vertical within the shell. In yet another variation, a flame is radially directed from the burner substantially toward the first longitudinal axis of the shell.

In the preferred embodiment, the shell is substantially cylindrical. However, the shell may have other shapes. In one variation, the shell has a cross-sectional area substantially in the form of an ellipse. In another variation, the shell has a cross-sectional area substantially in the form of a polygon.

Another embodiment of the invention is similar to the first embodiment of the apparatus but includes at least one refractory wall disposed in the shell adjacent the burner. The refractory wall is substantially perpendicular to the inner wall of the shell.

Yet another embodiment of the invention similar to the first embodiment of the apparatus has a particular burner arrangement using a plurality of elongated burner assemblies adjacent the inner wall. Each of the burner assemblies has a different longitudinal axis substantially parallel to the first and second longitudinal axes, a first end, and a second end opposite the first end. The first end of the burner assembly is adjacent the first end of the shell and the second end of the burner assembly is in the first region of the shell. The burner assemblies are substantially equally spaced apart peripherally around the inner wall and at least two neighboring burner assemblies are substantially equidistant from the reaction chamber. Each burner assembly is adapted to combust at least one fuel, thereby generating a flue gas in the first interior region of the shell. In all other respects, this embodiment is substantially the same as the first embodiment of the apparatus. As in the first embodiment, the reaction chamber(s), which preferably is a tubular device, is a reformer tube. The tubular device may be a reformer radiant tube or a tube-in-tube device.

Yet another embodiment of the invention is similar to the first embodiment of the apparatus but has a plurality of rays of one or more elongated reaction chambers (which may be reformer tubes). Each ray is substantially perpendicular to the inner wall of the shell. The rays divide the cross-sectional area of the shell into a plurality of equally-sized sectors having substantially identical shapes. At least one burner is disposed in each sector. Each of the reaction chambers has a design temperature and a different longitudinal axis substantially parallel to the first longitudinal axis and is substantially symmetrical about the different longitudinal axis. A first portion of each reaction chamber is disposed in the first interior region of the shell and a second portion of each of the reaction chambers is disposed in the second interior region of the shell. The first and second portions of the reaction chambers are adapted to contain a flow of the process fluid. In all other respects, this embodiment is substantially the same as the first embodiment of the apparatus.

Another aspect of the invention is a method for producing a product from a process for heating, reforming, or cracking hydrocarbon fluids or other fluids. The process may have a heat requirement for heating the process fluid.

A first embodiment of the method includes multiple steps. The first step is to provide an elongated shell having an inner wall, a first longitudinal axis, a first end, and a second end opposite the first end. The shell is substantially symmetrical about the first longitudinal axis and encloses a first interior region adjacent the first end and a second interior region adjacent the second end. Each of the first and second interior regions is substantially symmetrical about the first longitudinal axis. The second step is to provide at least one elongated reaction chamber having a design temperature and a second longitudinal axis substantially parallel to the first longitudinal axis. The reaction chamber is substantially symmetrical about the second longitudinal axis. A first portion of the reaction chamber is disposed in the first interior region of the shell and a second portion of the reaction chamber is disposed in the second interior region of the shell. The first and second portions of the reaction chamber are adapted to contain a flow of the process fluid. A third step is to provide a plurality of burners adjacent the inner wall, each of the burners being adapted to combust a fuel. The fourth step is to combust at least one fuel in at least one of the burners, thereby producing a flue gas in the first region of the shell and a variable heat flux. The variable heat flux substantially approximates the process heat requirement and simultaneously maximizes the heat flux to substantially all of the first portion of the reaction chamber while maintaining substantially all of the first portion substantially at the design temperature without substantially exceeding the design temperature. The fifth step is to transfer at least a portion of a flow of the flue gas from the first interior region of the shell to the second interior region of the shell. The sixth step is to feed at least a portion of the process fluid to the reaction chamber, wherein the portion of the process fluid absorbs at least a portion of the heat flux.

In a preferred embodiment of the method, the reaction chamber(s), which preferably is a tubular device, is a reformer tube. The tubular device may be a reformer radiant tube or tube-in-tube device.

There are many variations of the first embodiment of the method. In one variation, at least a portion of the process fluid flows through at least the first or second portion of the reaction chamber counter-currently with at least a portion of the flow of the flue gas. In another variation, a flame is radially directed from the burner substantially toward the first longitudinal axis of the shell.

Another embodiment of the method is similar to the first embodiment of the method but includes an additional step. The additional step is to withdraw a stream of the product from the reaction chamber. Yet another embodiment of the method is similar to the first embodiment except for the third step and the use of a particular burner arrangement. In the third step of this embodiment, a plurality of elongated burner assemblies are provided adjacent the inner wall. Each of the burner assemblies has a different longitudinal axis substantially parallel to the first and second longitudinal axes, a first end, and a second end opposite the first end. The first end of the burner assembly is adjacent the first end of the shell and the second end of the burner assembly is in the first region of the shell. The burner assemblies are substantially equally spaced apart peripherally around said inner wall and at least two neighboring burner assemblies are substantially equidistant from the reaction chamber. The burner assemblies are adapted to combust at least one fuel. In all other respects, this embodiment is substantially the same as the first embodiment of the method. The reaction chamber in this embodiment may be a reformer tube.

Yet another embodiment of the method is similar to the first embodiment of the method except for the second step. In the second step of this embodiment, a plurality of rays of one or more elongated reaction chambers are provided. Each ray is substantially perpendicular to the inner wall, and the rays divide the cross-sectional area of the shell into a plurality of equally-sized sectors having substantially identical shapes. Each of the reaction chambers has a design temperature and a different longitudinal axis substantially parallel to the first longitudinal axis. Each of the reaction chambers is substantially symmetrical about the different longitudinal axis. A first portion of the reaction chamber is disposed in the first interior region of the shell and a second portion of the reaction chamber is disposed in the second interior region of the shell. The first and second portions of the reaction chamber are adapted to contain a flow of the process fluid. With regard to the fourth step in this embodiment, at least one burner is disposed in each of the sectors. In all other respects, this embodiment is substantially the same as the first embodiment of the method.

Yet another aspect of the invention is a variable heat flux side-fired burner system for use in a process for heating, reforming, or cracking hydrocarbon fluids or other fluids, the process having a process heat requirement for heating a process fluid in at least one reaction chamber having a design temperature, a first portion, and a second portion. The burner system includes a plurality of adjacent burner units adapted to combust at least one fuel, thereby producing a variable heat flux. The variable heat flux substantially approximates the process heat requirement and simultaneously maximizes the heat flux to substantially all of a first portion of the reaction chamber while maintaining substantially all of the first portion substantially at the design temperature without substantially exceeding the design temperature.

There are several variations of the first embodiment of the burner system. In one variation, the adjacent burner units are equally spaced apart and each burner unit combusts the at least one fuel at a different firing rate. In another variation, the adjacent burner units are variably spaced apart and each burner unit combusts the at least one fuel at a substantially identical firing rate. In yet another variation, the adjacent burner units are variably spaced apart and each burner unit combusts the at least one fuel at a different firing rate. In still yet another variation, at least one burner unit combusts at least one first fuel or a fuel mixture containing said first fuel and at least one other burner unit combusts at least one second fuel or a fuel mixture containing said second fuel.

Another embodiment of the burner system is similar to the first embodiment but also includes a common fuel supply, a common air supply, means for regulating a flow of fuel to each burner unit from the common fuel supply, and means for regulating a flow of air to each burner unit from the common air supply.

### BRIEF DESCRIPTION OF SEVERAL VIEWS OF THE DRAWINGS

The invention will be described by way of example with reference to the accompanying drawings, in which:

FIG. 1 is a schematic partial cross-sectional elevation of a prior art reformer;

FIG. 2 is a schematic cross-sectional plan view of the prior art reformer shown in FIG. 1;

FIG. 3 is a schematic partial cross-sectional elevation of the apparatus for one embodiment of the invention;

FIG. 4 is a schematic cross-sectional plan view of the embodiment of the invention shown in FIG. 3;

FIG. 5 is a schematic partial cross-sectional elevation of the apparatus for another embodiment of the invention;

FIG. 6 is a schematic cross-sectional plan view of the embodiment of the invention shown in FIG. 5;

FIG. 7 is a schematic partial cross-sectional evaluation of the apparatus for another embodiment of the invention;

FIGS. 8, 9 and 10 are schematic cross-sectional plan views of the embodiment of the invention shown in FIG. 7;

FIG. 11 is a graph illustrating an S curve for a typical reformer tube at design conditions;

FIG. 12 is a graph illustrating the maximum heat flux as a function of process gas temperature;

FIG. 13 is a graph illustrating an optimal firing profile for a variable heat flux burner;

FIG. 14 is a graph illustrating tube heat flux distribution resulting from the optimal firing profile;

FIG. 15 is a graph illustrating the temperature distribution for flue gas, tube skin and process gas corresponding to the optimal firing profile;

FIG. 16 is a schematic diagram of a side view of one embodiment of a variable heat flux burner system including deflectors;

FIG. 17 is a schematic diagram of a front view of the variable heat flux burner system (of FIG. 16) without the deflectors;

FIG. 18 is a schematic diagram illustrating a variable heat flux burner system including a fuel supply distributor for distributing fuel to the burner units;

FIG. 19 is a schematic diagram of a burner tip;

FIG. 20 is a schematic diagram of another burner tip;

FIG. 21 is a schematic diagram illustrating a burner arrangement generating a flame having a sheet-like shape to provide a variable heat release pattern;

FIG. 22 is a schematic diagram illustrating another burner arrangement generating multiple flames to provide a variable heat release pattern; and

FIG. 23 is a schematic diagram illustrating another burner arrangement generating multiple flames to provide a variable heat release pattern.

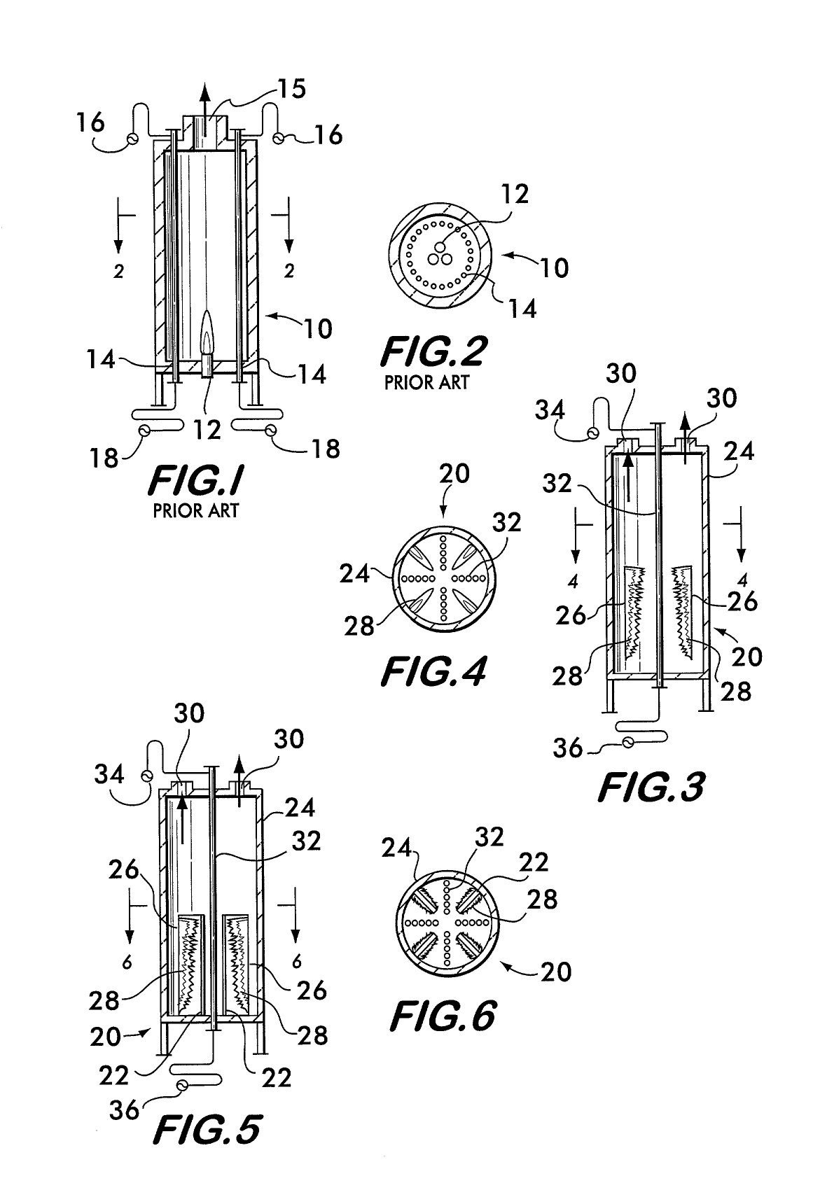

### DETAILED DESCRIPTION OF THE INVENTION

The invention is an apparatus and a method for an advanced reforming process using a variable heat flux side-fired burner system. The invention is not, however, limited to reforming applications. Persons skilled in the art will recognize that the apparatus, method, and burner system may be used in many other fired process heating applications, including but not limited to fluid heating and hydrocarbon cracking (e.g., ethylene cracking).

The process uses a reformer (or furnace) that has the following features: an integrated side-fired burner that produces a prescribed variable heat flux profile tailored to the process to achieve maximum capacity and maximum thermal efficiency, and avoids coking at the tube inlet; firing on both sides of tubes in the lower region (adjacent the tube outlet) to maximize the heat flux without overheating the tube (in the fired region) and no firing in the upper region, with optimal radiant heat transfer between the process gas and the flue gas due to counter-current flow; radially-directed firing and process tube alignment for optimal heat transfer around the tube circumference; unique burner system design to provide continuous and linear firing with variable heat flux; and optional refractory walls that extend radially from the inner wall of the furnace toward the center of the furnace, wherein the burners fire on both sides of each refractory wall, which helps to achieve the optimal heat flux distribution to the tubes.

FIGS. 3 and 4 show a schematic of the reformer 20 of the present invention (without optional refractory walls), and FIGS. 5 and 6 show a schematic of the reformer with optional refractory walls 22. Referring to FIGS. 3-6, the reformer 20 of the present invention includes a refractory lined shell 24. In a preferred embodiment, the shell is cylindrical. However, persons skilled in the art will recognize that the cross-sectional area of the shell may have alternate shapes, such as a polygon (e.g., a triangle, square, rectangle, pentagon, hexagon, octagon, etc.), an ellipse, or other shapes. Multiple variable heat flux burners 26 are located adjacent the inner wall of the shell 24 near the lower end of the shell. In a preferred embodiment, the burners are recessed in the refractory lining of the inner wall. As shown in FIGS. 3 and 5, envelopes of the flames 28 are sheet-like. At the upper end of the shell (opposite the burner end), there are one or more openings 30 that allow the flue gas (containing combustion products) to flow from the shell. Conventional reformer tubes 32 containing catalyst are positioned within the interior of the shell to utilize high intensive radiant heat directly from the flames of the burners. In the preferred embodiment, the burners are equally spaced apart peripherally around the inner wall of the reformer, with neighboring burners being equidistant from one or more reformer tubes positioned in a vertical plane midway between the neighboring burners.

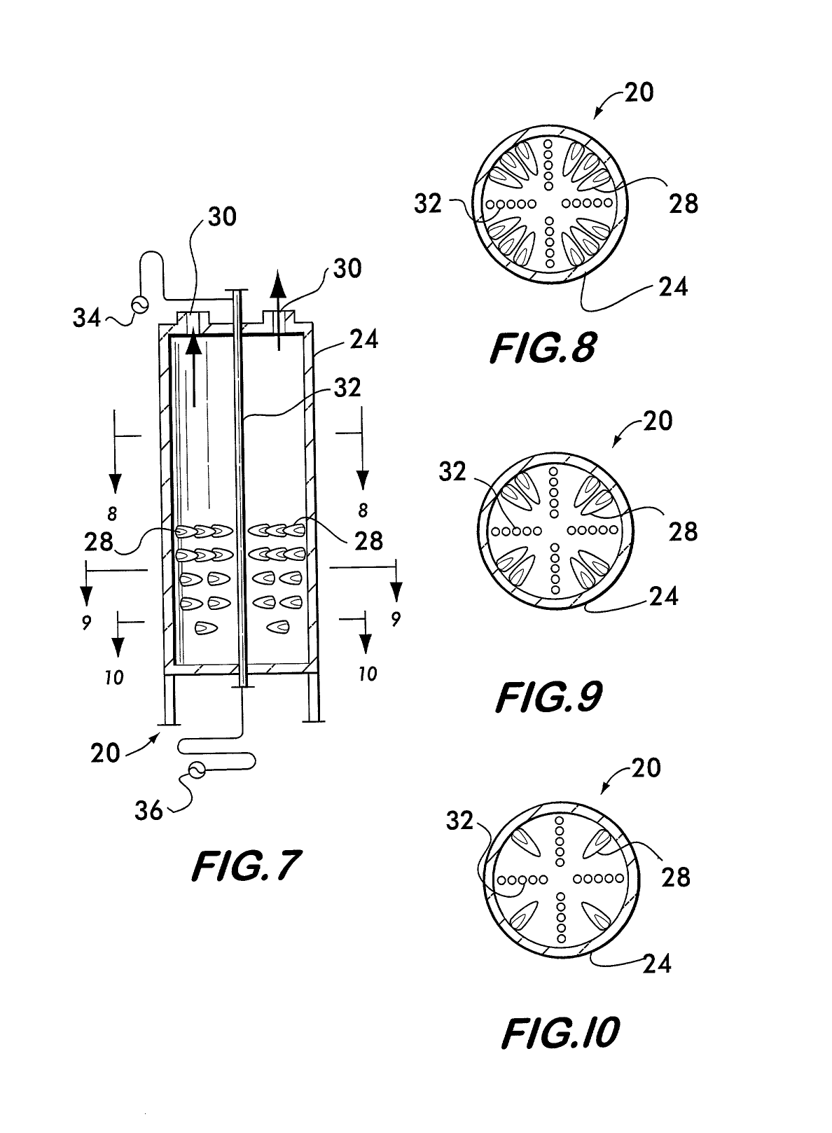

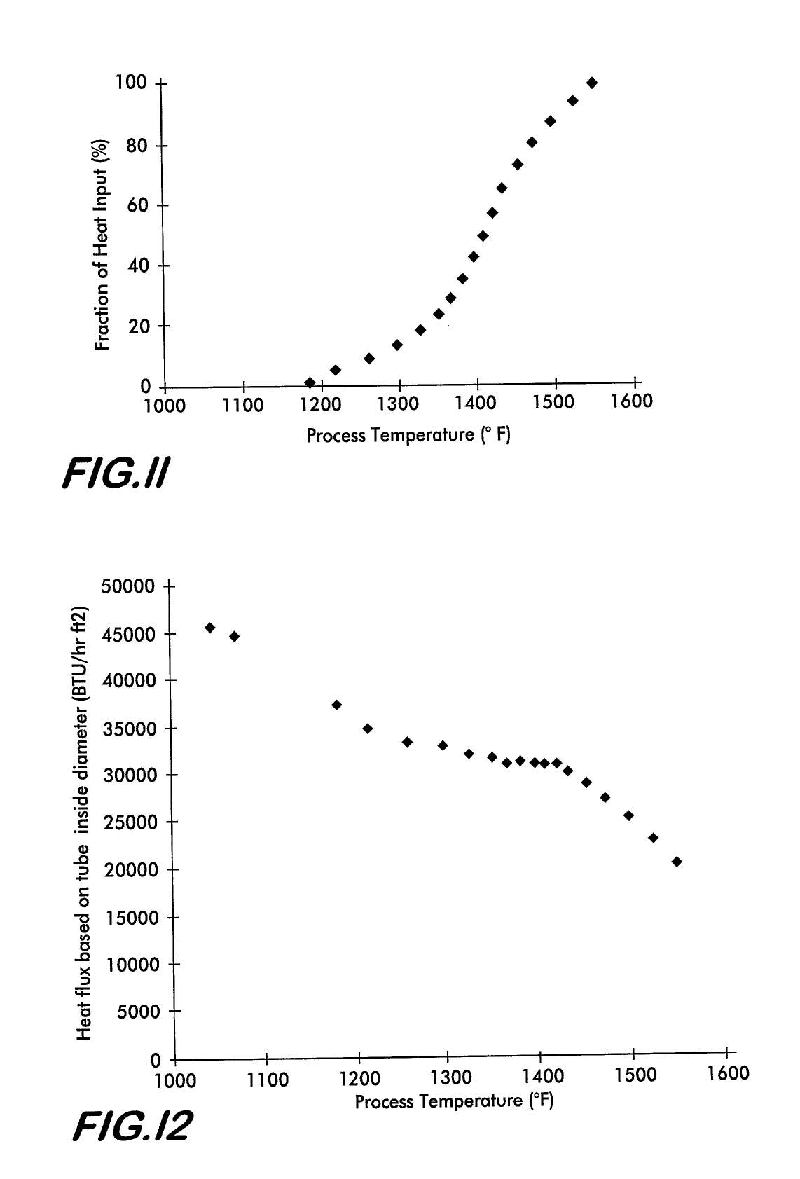

Persons skilled in the art will recognize that the burners may be arranged differently in other embodiments, one of which is illustrated in FIGS. 7-10. As shown in FIG. 7, one or more burners 26 may be arranged within each of the (four) sectors of the reformer 20 to achieve the desired variable heat flux profile to the tubes 32 in the lower region of the reformer. As shown in FIGS. 8, 9 and 10, multiple burners are fired in each pie-shaped sector (“quadrant”) at different elevations on both sides of tubes arranged in a given ray of tubes. FIG. 8 shows three burners firing within each quadrant and within a given slice of the reformer as a means of increasing the heat release rate within that slice of the furnace. FIG. 9 shows two burners firing within each quadrant and within a given slice of the reformer as a means of increasing the heat release rate within that slice of the furnace. And FIG. 10 shows one burner firing within each quadrant and within a given slice of the reformer as a means of increasing the heat release rate within that slice of the furnace. The burners in FIGS. 7-10 are arranged as shown to ensure that the amount of heat that a given segment of each tube receives is approximately equal. (Persons skilled in the art will recognize that many burner arrangements other than that shown in FIGS. 7-10 are feasible. For example, one or more additional burners could be added in each sector at each elevation in FIGS. 8-10.)

In the preferred embodiment, the tubes 32 are arranged in four sectors of the reformer 20 and one variable heat flux burner 26 is located at the inner wall in each sector, as shown in FIGS. 4 and 6. (Persons skilled in the art will recognize that the reformer may be evenly divided into any number of equally-sized sectors with a ray of tubes in each sector.) Each burner produces a substantially continuous flame along the height of the burner. The flame front only extends a short distance from the burner toward the centerline of the reformer. Heat is radiated directly from the flame and the burner tile to the tubes and is emitted and reflected from the inner wall. Mixed-feed enters the inlet header 34 and is distributed to the upper end of each reformer tube 32. Product synthesis gas exits at the lower end of each reformer tube and is removed from the reformer at the outlet header 36, and the flue gas exits from openings 30 at the top of the reformer.

FIGS. 5 and 6 show a reformer that incorporates four vertical refractory walls 22, one in each sector. The hot flue gases (containing combustion products) flow radially across both sides of each refractory wall, which is thereby heated and radiates heat to the tubes. The refractory walls 22 are perpendicular to the inner wall of the shell 24. These refractory walls may be made of a composite of conventional refractory materials, such as high temperature fired bricks, or a solid casting of a refractory, such as alumina.

Fuel is fired in the lower region of the reformer 20. The fuel is fired via the variable heat flux burners 26, which produce a prescribed heat flux profile along the tube length—one that is tailored to the specific requirements of the process (reforming, or cracking, or other) taking place inside the tube. This prescribed heat flux profile simultaneously addresses constraints such as design tube metal temperature and coking, and maximizes average heat flux (capacity) and thermal efficiency.

The heat flux profile produced by the variable heat flux burner 26 is designed to radiate the maximum amount of heat to each segment of the tube 32 in the fired zone without exceeding the tube design temperature limits. The objective is to provide the maximum possible heat flux through each tube segment that is located in the vicinity of the process outlet. (For reforming applications, the maximum heat flux is tied to the reforming reaction process that occurs as the gas flows through the tube.) As an intentional result, the tube wall temperature is maintained at a uniform value over most of the entire fired length of the tube.

For a cylindrical reformer design, each variable heat flux burner 26 is located along the inner wall of the reformer 20 mid-way between two rays of tubes 32 (as illustrated in FIGS. 4 and 6), and an optional refractory wall 22 extends in the radial direction along the center line of each burner (as illustrated in FIG. 6). The optional refractory walls are incorporated along the height of the fired region, but not in the unfired region. The refractory walls are used to ensure that the optimal heat flux distribution is attained in the fired region.

In the preferred embodiment, each variable heat flux burner 26 fires fuel substantially continuously over the height of the reformer 20 occupied by the burner. The heat release intensity per unit length of the burner is very low and varies smoothly along the height of the burner.

The firing rate per burner 26 can be varied for startup and operation at reduced production rates. An objective is to achieve the same relative heat release profile (% of total heat release versus burner height) over the burner capacity range. (Persons skilled in the art will recognize that an adjustable burner could be designed to vary the relative heat release profile.) In this way, the variable heat flux profile produced by the burner satisfies all of the constraints (e.g., tube temperature, coking problem) over the turndown range. At turndown conditions, the tube wall temperature will again be similar to design conditions, only cooler.

For the configurations shown in FIGS. 3 and 5, combustion products flow upward. The combustion products produced by the lower sections of the variable heat flux burners 26 combine with the combustion products produced by the upper sections of the burners and flow upward.

The upper region of the reformer 20 is not fired. The flue gas (containing combustion products) flows counter-currently with the incoming process gas and exits at the top of the reformer. Counter-current flow helps to maximize the heat flux to the tubes in the upper region of the furnace by maximizing the temperature driving force.

This arrangement helps to maximize throughput (capacity) while simultaneously achieving maximum possible radiant efficiency. The improvement in radiant efficiency at reduced rates will be even better than any improvement realized with co-current reforming technology.

The burner and tile design, as well as the design layout of the reforming tubes 32, achieve a uniform heat flux at each elevation in the reformer 20, both around the circumference of individual tubes and from tube to tube. As a result, the ratio of the peak heat flux to the worst tube (tube with the maximum local heat flux at a given elevation) and the average heat flux to all the tubes at the same elevation is held as close to unity as possible. The optional refractory walls 22 further ensure that this challenging objective is met.

FIG. 11 plots the process duty-process temperature curve, also known as an S curve, for typical reformer tube design conditions (space velocity, catalyst size and shape, end-of-run catalyst activity). This plot is obtained from a steam methane reformer simulation program. At a given distance from the inlet of the tube, an amount of heat is transferred to the process gas that causes both the sensible and chemical enthalpy of the process gas to increase. The S curve plots the fraction of heat absorbed (from the inlet to a given point inside the tube) versus the process gas temperature at that point.

The reformer tube is designed for a given operating life corresponding with specified limits on tube wall temperature and process pressure. Once the local conditions inside of the tube are known, it is possible to calculate the maximum local heat flux that the tube can sustain. FIG. 12 plots the maximum heat flux as a function of the process temperature for the conditions corresponding to FIG. 11.

From the above discussion, it is clear that limits exist on the magnitude of heat flux to the tube and these limits depend on the process temperature and extent of the reforming reaction. This information is of key importance in specifying the design requirements of the variable heat flux burner for the side-fired application. To maximize the reformer efficiency with downward process flow, it is desirable to maximize the firing in the bottom region of the reformer and to allow counter-current heat exchange between the combustion products and incoming process gas.

FIG. 13 illustrates the shape of the optimal firing profile for reforming natural gas with steam to produce hydrogen. This profile is for one specified design tube metal temperature and specific fixed process conditions. In other words, the reformer tubes are designed for one temperature and the process conditions of temperature and pressure are fixed, as is the capacity (i.e., fixed amounts of natural gas and steam are fed to the reformer). The amount of fuel fired per unit increment of reformer height tends to increase from a low value at the bottom of the reformer. The amount of fuel fired to the upper-most section of the burner tends to be less than the amount set by tube temperature constraints (reach target on total firing duty).

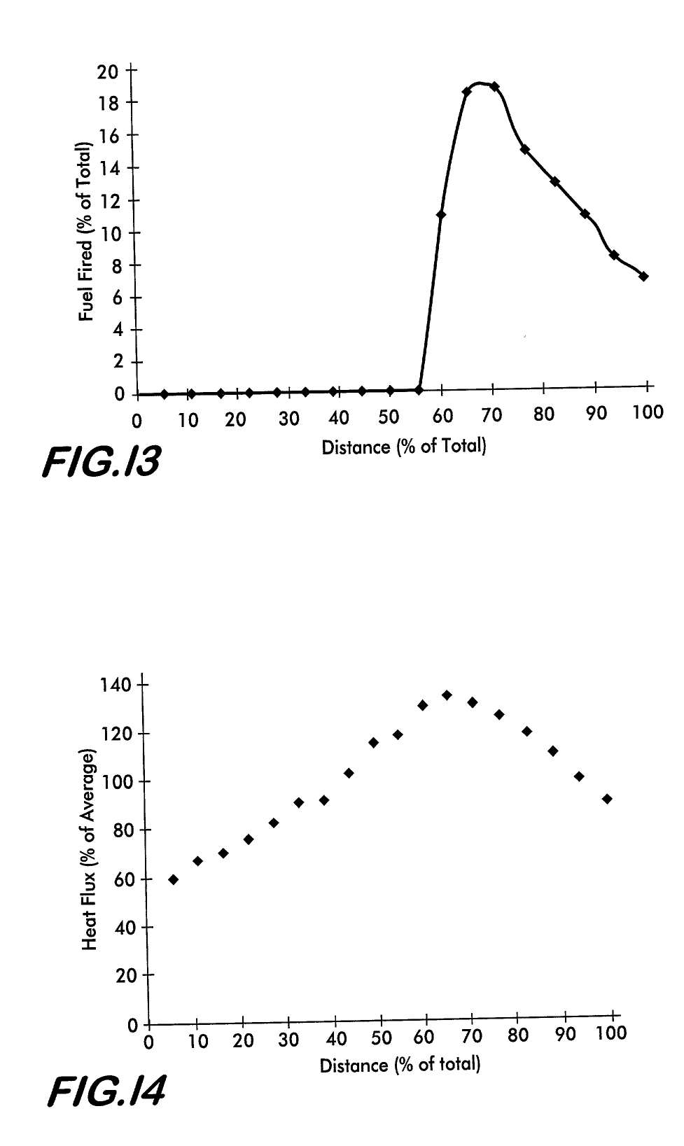

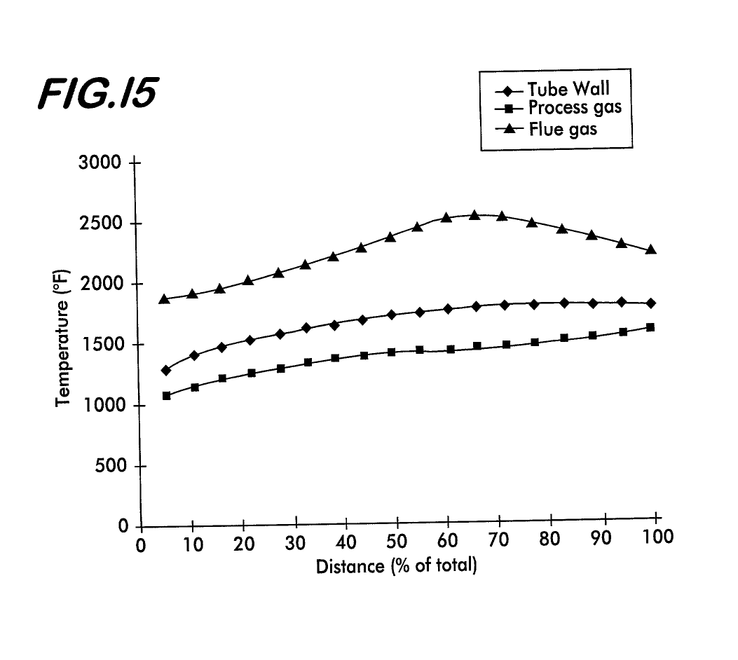

FIG. 14 shows the corresponding tube heat flux profile. In the fired region, the heat flux reaches the maximum heat flux limits as shown in FIG. 12. In the unfired region, the heat fluxes are below these limits.

FIG. 15 plots the corresponding temperature profiles for flue gas, tube wall and process gas. In the fired region, the tube wall temperature is held at the design limits. With counter-current flow, the difference between the flue gas and tube wall temperatures is maximized and the temperature profiles do not pinch at the flue gas exit.

The advantages of the novel burner and arrangement of the present invention include:

the variable heat flux burner produces the desired heat flux profile along the tube to maintain relatively constant reformer tube metal temperature in the fired region;

fewer burners, piping, valves and instrumentation are required, thereby minimizing capital cost for the reformer, or heater, or ethylene cracker; and

the furnace (or reformer) is capable of producing higher capacity and higher radiant efficiency. Also, the unique placement of the variable heat flux burner solves the coking problem that occurs at the tube inlet (in conventional reformers) and extends run time between catalyst changes.

In a typical commercial reformer, such as that illustrated schematically in FIG. 1, process gas flow is upward and the reformer 10 is up-fired from three burners 12 located near the center of the furnace floor. The reformer contains tubes in a cylindrical arrangement.

TABLE 1
Comparison of physical configuration

| | | Present |
|---|---|---|
| Reformer Design | Prior Art | Invention |
| Number of burners | 3 | 4 |
| Firing direction | Upward | Side |
| Process flow direction | Upward | Downward |

In comparing a typical commercial reformer with a reformer according to the present invention, the following parameters were kept at the same values for both reformers for the comparison:

inside furnace diameter;

inside furnace height;

reformer tube design temperature and pressure;

catalyst activity;

catalyst size and shape (single hole);

air preheat temperature; and

steam-to-carbon (S/C) ratio.

The following benefits of the reformer according to the present invention were expected in making this comparison:

30% increase in H₂ production capacity (with same size furnace);

12% less firing per unit H₂ production;

convection section is smaller because of 12% reduction in flue gas flow;

38% less catalyst per unit H₂ production;

40% less tube material per unit H₂ capacity; and

40% increase in average heat flux based on inside tube surface area.

Additional work also was done to examine the heat flux distributions within this novel reformer which utilizes variable heat flux burners. The results indicate (for a furnace with 4 sectors) that the heat flux around the tubes and from tube to tube is expected to be uniform at each elevation.

FIGS. 16-23 show several arrangements of the variable heat flux burner 26 of the present invention. (Persons skilled in the art will recognize that other burner arrangements are possible.) An important feature of the burner used in the preferred embodiment of the present invention is that it is a relatively long burner, preferably oriented in the vertical direction on the inner wall of the reformer 20. To be flexible, the burner may be divided into multiple sections, as shown in FIGS. 16-18. But all sections preferably share a common air supply 38 and a common fuel supply 40. This way, the piping, valves, and controls are simplified. Each section has a predetermined firing pattern. When joined together, the multi-section burner produces a heat release profile that optimally matches for the process conditions.

As shown in FIGS. 16-18, each section has the same way of introducing fuel and air that produces a compact flame, similar to a conventional wall radiant burner. But it is stressed that FIGS. 16-18, show a single burner 26 with multiple sections, rather than multiple burners, because all sections share a common air supply 38, a common fuel supply 40, and a common burner control system (not shown).

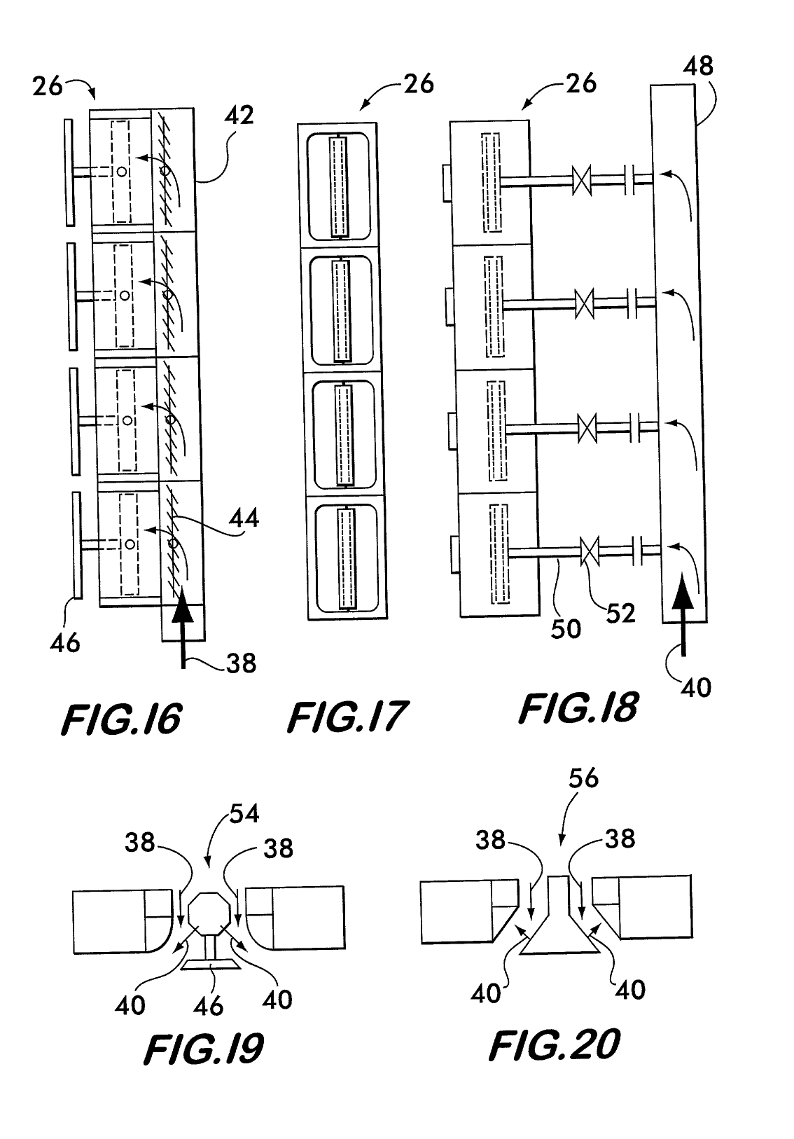

FIG. 16 is a side view of one design of a variable heat flux burner 26 used in the present invention. Air 38 enters a conduit 42 at the bottom or top of the burner and air flow to each burner unit or section is regulated by a damper 44. A flame deflector 46 may be associated with each burner unit or section to shape the flame. FIG. 17 provides a view of the burner without deflectors as viewed from inside the reformer 20. FIG. 18 provides a view of the burner from outside of the reformer 20 showing the supply of fuel 40 to the individual burner units or sections via a distribution system including a manifold 48, piping 50 and control valves 52. Different types of burner tips may be used with the burner 26. FIG. 19 is a schematic of one such burner tip 54, and FIG. 20 is a schematic of another such burner tip 56.

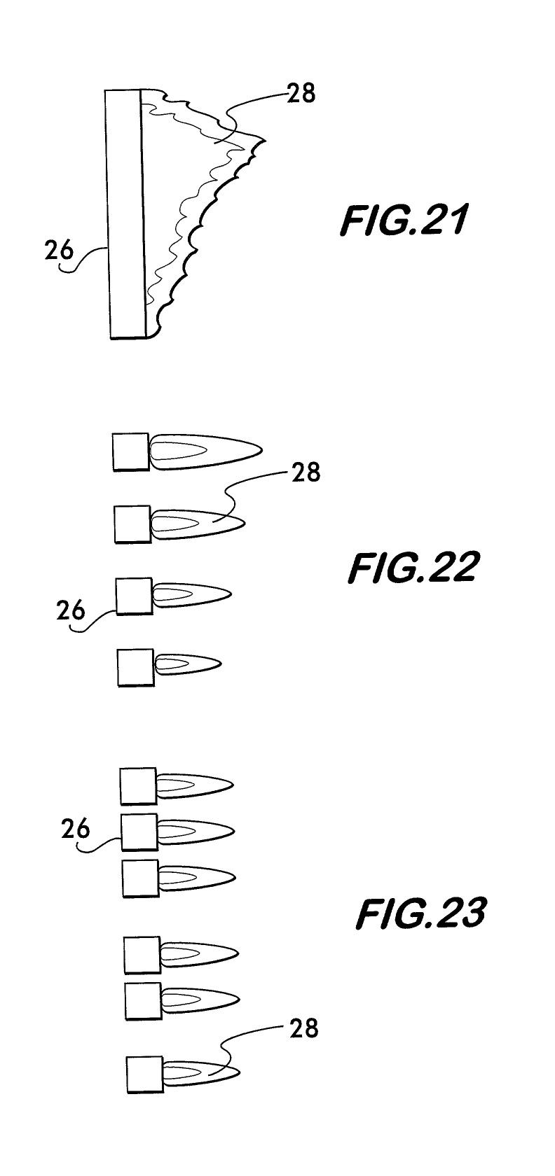

As indicated, the flame 28 in the preferred embodiment has a sheet-like shape shown in FIG. 3 and also in FIG. 21. The sheet-like shape may be generated from a variable heat flux burner 26 such as that illustrated in FIGS. 16-18. However, other burner arrangements and flame shapes, such as those shown in FIGS. 22 and 23, also may be used to generate the variable heat release pattern in the present invention. For the arrangement illustrated in FIG. 22, the burner units are equally spaced but each unit is designed to fire at a different firing rate to generate a variable heat release pattern. For the arrangement illustrated in FIG. 23, all burner units are designed to fire at the same firing rate and the spacing between burner units is varied to provide a variable heat release pattern. A variable burner unit spacing can also be combined with burner units designed to fire at different rates to achieve the prescribed heat flux profile.

Although each burner unit in the preferred embodiment of the invention burns the same fuel, different fuels may be used in alternate embodiments. For example, selected burner units may be designed to fire a liquid fuel (such as naphtha) and other burner units may be designed to burn a gaseous fuel (such as the offgas produced from pressure swing adsorption). It also is feasible for selected burner units to be designed to fire a mixture of fuels (such as a mixture of natural gas and offgas from pressure swing adsorption).

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

1. An apparatus for heating, reforming, or cracking hydrocarbon fluids or other fluids in a process having a process heat requirement for heating a process fluid in the process, comprising:
an elongated shell having an inner wall, a first longitudinal axis, a first end, and a second end opposite said first end, said shell being substantially symmetrical about said first longitudinal axis and enclosing a first interior region adjacent the first end and a second interior region adjacent the second end, each of said first and second interior regions being substantially symmetrical about said first longitudinal axis;
at least one elongated reaction chamber having a design temperature and a second longitudinal axis substantially parallel to said first longitudinal axis, said reaction chamber being substantially symmetrical about said second longitudinal axis, a first portion of said reaction chamber being disposed in said first interior region of said shell and a second portion of said reaction chamber being disposed in said second interior region of said shell, said first and second portions of said reaction chamber adapted to contain a flow of said process fluid;
a plurality of burners adjacent said inner wall, each of said burners adapted to combust at least one fuel, thereby producing a flue gas in said first interior region of said shell and a variable heat flux substantially approximating said process heat requirement and simultaneously maximizing said heat flux to substantially all of said first portion of said reaction chamber while maintaining substantially all of said first portion substantially at said design temperature without substantially exceeding said design temperature; and
transfer means adjacent the second end of said shell, whereby at least a portion of a flow of said flue gas flows from the first interior region of said shell to the second interior region of said shell.

2. An apparatus as in claim 1, wherein at least a portion of said process fluid flows through at least the first or second portion of said reaction chamber counter-currently with at least a portion of said flow of said flue gas.

3. An apparatus as in claim 1, wherein a substantial portion of said reaction chamber is substantially vertical within said shell.

4. An apparatus as in claim 1, wherein said shell is substantially cylindrical.

5. An apparatus as in claim 1, wherein said shell has a cross-sectional area substantially in the form of an ellipse.

6. An apparatus as in claim 1, wherein said shell has a cross-sectional area substantially in the form of a polygon.

7. An apparatus as in claim 1, wherein a flame is radially directed from said burner substantially toward said first longitudinal axis of said shell.

8. An apparatus as in claim 1, further comprising at least one refractory wall disposed in said shell adjacent said burner, said refractory wall being substantially perpendicular to said inner wall.

9. An apparatus for heating, reforming, or cracking hydrocarbon fluids or other fluids in a process having a process heat requirement for heating a process fluid in the process, comprising:
an elongated shell having an inner wall, a first longitudinal axis, a first end, and a second end opposite said first end, said shell being substantially symmetrical about said first longitudinal axis and enclosing a first interior region adjacent the first end and a second interior region adjacent the second end, each of said first and second interior regions being substantially symmetrical about said first longitudinal axis;
at least one elongated reformer tube having a design temperature and a second longitudinal axis substantially parallel to said first longitudinal axis, said reformer tube being substantially symmetrical about said second longitudinal axis, a first portion of said reformer tube being disposed in said first interior region of said shell and a second portion of said reformer tube being disposed in said second interior region of said shell, said first and second portions of said reformer tube adapted to contain a flow of said process fluid;
a plurality of burners adjacent said inner wall, each of said burners adapted to combust at least one fuel, thereby producing a flue gas in said first interior region of said shell and a variable heat flux substantially approximating said process heat requirement and simultaneously maximizing said heat flux to substantially all of said first portion of said reformer tube while maintaining substantially all of said first portion substantially at said design temperature without substantially exceeding said design temperature; and
transfer means adjacent the second end of said shell, whereby at least a portion of a flow of said flue gas flows from the first interior region of said shell to the second interior region of said shell.

10. An apparatus for heating, reforming, or cracking hydrocarbon fluids or other fluids, comprising:
an elongated shell having an inner wall, a first longitudinal axis, a first end, and a second end opposite said first end, said shell being substantially symmetrical about said first longitudinal axis and enclosing a first interior region adjacent the first end and a second interior region adjacent the second end, each of said first and second interior regions being substantially symmetrical about said first longitudinal axis;
at least one elongated reaction chamber having a second longitudinal axis substantially parallel to said first longitudinal axis, said reaction chamber being substantially symmetrical about said second longitudinal axis, a first portion of said reaction chamber being disposed in said first interior region of said shell and a second portion of said reaction chamber being disposed in said second interior region of said shell;
a plurality of elongated burner assemblies adjacent said inner wall, each of said burner assemblies having a different longitudinal axis substantially parallel to said first and second longitudinal axes, a first end, and a second end opposite said first end, the first end of said burner assembly being adjacent the first end of said shell and the second end of said burner assembly being in said first region of said shell, said burner assemblies being substantially equally spaced apart peripherally around said inner wall and at least two neighboring burner assemblies being substantially equidistant from said reaction chamber, each said burner assembly adapted to combust at least one fuel, thereby generating a flue gas in said first interior region of said shell; and
transfer means adjacent the second end of said shell whereby at least a portion of a flow of said flue gas flows from the first interior region of said shell to the second interior region of said shell.

11. An apparatus as in claim 10, wherein said reaction chamber is a reformer tube.

12. An apparatus for heating, reforming, or cracking hydrocarbon fluids or other fluids in a process having a process heat requirement for heating a process fluid in the process, comprising:
an elongated shell having an inner wall, a first longitudinal axis, a cross-sectional area, a first end, and a second end opposite said first end, said shell being substantially symmetrical about said first longitudinal axis and enclosing a first interior region adjacent the first end and a second interior region adjacent the second end, each of said first and second interior regions being substantially symmetrical about said first longitudinal axis;
a plurality of rays of one or more elongated reaction chambers, each ray being substantially perpendicular to said inner wall, said rays dividing said cross-sectional area into a plurality of equally-sized sectors having substantially identical shapes, each of said reaction chambers having a design temperature and a different longitudinal axis substantially parallel to said first longitudinal axis, and being substantially symmetrical about said different longitudinal axis, a first portion of each said reaction chamber being disposed in said first interior region of said shell and a second portion of each said reaction chamber being disposed in said second interior region of said shell, said first and second portions of said reaction chamber adapted to contain a flow of said process fluid;
a plurality of burners adjacent said inner wall, at least one burner being disposed in each said sector and each of said burners adapted to combust at least one fuel, thereby producing a flue gas in said first interior region of said shell and a variable heat flux substantially approximating said process heat requirement and simultaneously maximizing said heat flux to substantially all of said first portion of each reaction chamber while maintaining substantially all of said first portion substantially at said design temperature without substantially exceeding said design temperature; and
transfer means adjacent the second end of said shell, whereby at least a portion of a flow of said flue gas flows from the first interior region of said shell to the second interior region of said shell.

13. A method for producing a product from a process for heating, reforming, or cracking hydrocarbon fluids or other fluids, the process having a process heat requirement for heating a process fluid, comprising the steps of:
providing an elongated shell having an inner wall, a first longitudinal axis, a first end, and a second end opposite said first end, said shell being substantially symmetrical about said first longitudinal axis and enclosing a first interior region adjacent the first end and a second interior region adjacent the second end, each of said first and second interior regions being substantially symmetrical about said first longitudinal axis;
providing at least one elongated reaction chamber having a design temperature and a second longitudinal axis substantially parallel to said first longitudinal axis, said reaction chamber being substantially symmetrical about said second longitudinal axis, a first portion of said reaction chamber being disposed in said first interior region of said shell and a second portion of said reaction chamber being disposed in said second interior region of said shell, said first and second portions of said reaction chamber adapted to contain a flow of said process fluid;
providing a plurality of burners adjacent said inner wall, each of said burners adapted to combust at least one fuel;
combusting said at least one fuel in at least one of said burners, thereby producing a flue gas in said first region of said shell and a variable heat flux substantially approximating said process heat requirement and simultaneously maximizing said heat flux to substantially all of said first portion of said reaction chamber while maintaining substantially all of said first portion substantially at said design temperature without substantially exceeding said design temperature;
transferring at least a portion of a flow of said flue gas from said first interior region of said shell to said second interior region of said shell; and
feeding at least a portion of said process fluid to said reaction chamber, wherein said portion of said process fluid absorbs at least a portion of said heat flux.

14. A method as in claim 13, comprising the further step of withdrawing a stream of the product from said reaction chamber.

15. A method as in claim 13, wherein at least a portion of said process fluid flows through at least the first or second portion of said reaction chamber counter-currently with at least a portion of said flow of said flue gas.

16. A method as in claim 13, wherein a flame is radially directed from said burner substantially toward said first longitudinal axis of said shell.

17. A method for producing a product from a process for heating, reforming, or cracking hydrocarbon fluids or other fluids, the process having a process heat requirement for heating a process fluid, comprising the steps of:
providing an elongated shell having an inner wall, a first longitudinal axis, a first end, and a second end opposite said first end, said shell being substantially symmetrical about said first longitudinal axis and having a first interior region adjacent the first end and a second interior region adjacent the second end, each of said first and second regions being substantially symmetrical about said first longitudinal axis;
providing at least one elongated reformer tube having a design temperature and a second longitudinal axis substantially parallel to said first longitudinal axis, said reformer tube being substantially symmetrical about said second longitudinal axis, a first portion of said reformer tube being disposed in said first interior region of said shell and a second portion of said reformer tube being disposed in said second interior region of said shell, said first and second portions of said reformer tube adapted to contain a flow of said process fluid;
providing a plurality of burners adjacent said inner wall, each of said burners adapted to combust at least one fuel;
combusting at least one fuel in at least one of said burners, thereby producing a flue gas in said first region of said shell and a variable heat flux substantially approximating said process heat requirement and simultaneously maximizing said heat flux to substantially all of said first portion of said reformer tube while maintaining substantially all of said first portion substantially at said design temperature without substantially exceeding said design temperature;
transferring at least a portion of a flow of said flue gas from said first interior region of said shell to said second interior region of said shell; and
feeding at least a portion of said process fluid to said reformer tube, wherein said portion of said process fluid absorbs at least a portion of said heat flux.

18. A method for producing a product from a process for heating, reforming, or cracking hydrocarbon fluids or other fluids, comprising the steps of:
providing an elongated shell having an inner wall, a first longitudinal axis, a first end, and a second end opposite said first end, said shell being substantially symmetrical about said first longitudinal axis and enclosing a first interior region adjacent the first end and a second interior region adjacent the second end, each of said first and second interior regions being substantially symmetrical about said first longitudinal axis;
providing at least one elongated reaction chamber having a second longitudinal axis substantially parallel to said first longitudinal axis, said reaction chamber being substantially symmetrical about said second longitudinal axis, a first portion of said reaction chamber being disposed in said first interior region of said shell and a second portion of said reaction chamber being disposed in said second interior region of said shell;
providing a plurality of elongated burner assemblies adjacent said inner wall, each of said burner assemblies having a different longitudinal axis substantially parallel to said first and second longitudinal axes, a first end, and a second end opposite said first end, the first end of said burner assembly being adjacent the first end of said shell and the second end of said burner assembly being in said first region of said shell, said burner assemblies being substantially equally spaced apart peripherally around said inner wall and at least two neighboring burner assemblies being substantially equidistant from said reaction chamber, said burner assemblies adapted to combust at least one fuel;
combusting said at least one fuel in at least one of said burner assemblies, thereby producing a combustion heat and a flue gas in said first interior region of said shell;
transferring at least a portion of a flow of said flue gas from said first interior region of said shell to said second interior region of said shell; and
feeding at least a portion of a process fluid to said reaction chamber, wherein said portion of said process fluid absorbs at least a portion of said combustion heat.

19. A method as in claim 18, wherein said reaction chamber is a reformer tube.

20. A method for producing a product from a process for heating, reforming, or cracking hydrocarbon fluids or other fluids, the process having a process heat requirement for heating a process fluid, comprising the steps of:
providing an elongated shell having an inner wall, a first longitudinal axis, a cross-sectional area, a first end, and a second end opposite said first end, said shell being substantially symmetrical about said first longitudinal axis and enclosing a first interior region adjacent the first end and a second interior region adjacent the second end, each of said first and second interior regions being substantially symmetrical about said first longitudinal axis;
providing a plurality of rays of one or more elongated reaction chambers, each ray being substantially perpendicular to said inner wall, said rays dividing said cross-sectional area into a plurality of equally-sized sectors having substantially identical shapes, each of said reaction chambers having a design temperature and a different longitudinal axis substantially parallel to said first longitudinal axis, and being substantially symmetrical about said different longitudinal axis, a first portion of each said reaction chamber being disposed in said first interior region of said shell and a second portion of each said reaction chamber being disposed in said second interior region of said shell, said first and second portions of said reaction chamber adapted to contain a flow of said process fluid;
providing a plurality of burners adjacent said inner wall, at least one burner being disposed in each said sector and each of said burners adapted to combust at least one fuel;
combusting said at least one fuel in at least one of said burners, thereby producing a flue gas in said first interior region of said shell and a variable heat flux substantially approximating said process heat requirement and simultaneously maximizing said heat flux to substantially all of said first portion of said reaction chamber while maintaining substantially all of said first portion substantially at said design temperature without substantially exceeding said design temperature;
transferring at least a portion of a flow of said flue gas from said first interior region of said shell to said second interior region of said shell; and
feeding at least a portion of said process fluid to said reaction chamber, wherein said portion of said process fluid absorbs at least a portion of said heat flux.

21. A variable heat flux side-fired burner system for use in a process for heating, reforming, or cracking hydrocarbon fluids or other fluids, the process having a process heat requirement for heating a process fluid in at least one reaction chamber having a design temperature, a first portion, and a second portion, comprising:
a plurality of adjacent burner units adapted to combust at least one fuel, thereby producing a variable heat flux substantially approximating said process heat requirement and simultaneously maximizing said heat flux to substantially all of said first portion of said reaction chamber while maintaining substantially all of said first portion substantially at said design temperature without exceeding said design temperature of said reaction chamber.

22. A variable heat flux side-fired burner system as in claim 21, further comprising:
a common fuel supply;
a common air supply;
means for regulating a flow of fuel to each burner unit from said common fuel supply; and
means for regulating a flow of air to each burner unit from said common air supply.

23. A variable heat flux side-fired burner system as in claim 21, wherein said adjacent burner units are equally spaced apart and each burner unit combusts said at least one fuel at a different firing rate.

24. A variable heat flux side-fired burner system as in claim 21, wherein said adjacent burner units are variably spaced apart and each burner unit combusts said at least one fuel at a substantially identical firing rate.

25. A variable heat flux side-fired burner system as in claim 21, wherein said adjacent burner units are variably spaced apart and each burner unit combusts said at least one fuel at a different firing rate.

26. A variable heat flux side-fired burner system as in claim 21, wherein at least one burner unit combusts at least one first fuel or a fuel mixture containing said first fuel t least one other burner unit combusts at least one second fuel or a fuel mixture containing said second fuel.
